(19) United States
(12) Patent Application Publication
(10) Pub. No.: US 2026/0322949 A1
(43) Pub. Date: Oct. 15, 2026

(54) DISPLAY SYSTEM, REMOTE DRIVING DEVICE AND DISPLAY CONTROL METHOD

(71) Applicants: KOMATSU LTD., Tokyo (JP); NATIONAL INSTITUTE OF ADVANCED INDUSTRIAL SCIENCE AND TECHNOLOGY, Tokyo (JP)

(72) Inventors: Yukinori MATSUMURA, Tokyo (JP); Koji OKUDA, Tokyo (JP); Junji OHYAMA, Tsukuba-shi (JP); Hiroshi ENDOU, Tsukuba-shi (JP); Hiroshi WATANABE, Tsukuba-shi (JP)

(21) Appl. No.: 19/122,609

(22) PCT Filed: Oct. 18, 2023
(86) PCT No.: PCT/JP2023/037743

§ 371 Date: Apr. 18, 2025

(30) Foreign Application Priority Data
Oct. 31, 2022 (JP) 2022-175051

(51) Int. Cl. H04N 7/18; E02F 3/32; E02F 9/20; E02F 9/26; H04N 23/90

(52) U.S. Cl. CPC H04N 7/181; E02F 9/205; E02F 9/261; H04N 23/90; E02F 3/32

(57) ABSTRACT

A display system is used for operating a work machine including a rotating body that rotates about a center of rotation. The display system includes a display device, and a display control device configured to output a display signal in order to display an image on the display device. The display control device includes an acquisition unit, a rotation determination unit, and a display control unit. The acquisition unit acquires an environmental image showing a direction faced by the rotating body in a peripheral environment of the work machine. The rotation determination unit determines whether or not the rotating body is rotating. The display control unit outputs, to the display device, a display signal in order to display an image in which a side of the environmental image opposite to a rotation direction is blocked when the rotating body is determined to be rotating.

### CROSS-REFERENCE TO RELATED APPLICATIONS

This application is a U.S. National stage application of International Application No. PCT/JP2023/037743, filed on Oct. 18, 2023. This U.S. National stage application claims priority under 35 U.S.C. § 119(a) to Japanese Patent Application No. 2022-175051, filed in Japan on Oct. 31, 2022, the entire contents of which are hereby incorporated herein by reference.

### BACKGROUND

### Technical Field The present disclosure relates to a remote driving device and a display control method.

### Background Information

Technology for aiding the remote operation of a work machine by an operator by displaying, on a display device provided at a remote location, video images from an imaging device provided on the work machine is known (for example, Japanese Unexamined Patent Application, First Publication No. H9-218713).

### SUMMARY

In order to reduce the gap between remote operation and actual machine operation, it is desirable to construct, in the remote driving device, an environment close to that when an operator actually boards a work machine. Therefore, the video images from the imaging device provided on the work machine are required to be displayed on a large screen.

However, when an entire screen occupying much of the field of view of an operator moves in unison due to rotation of the work machine, there is a possibility that the operator will experience motion sickness.

An objective of the present disclosure is to provide a display system, a remote driving device, and a display control method that can prevent motion sickness in an operator.

According to one embodiment of the present invention, a display system is a display system used for operating a work machine comprised a rotating body that rotates about a center of rotation, the display system comprising a display device and a display control device that outputs a display signal for displaying an image on the display device, wherein the display control device comprises an acquisition unit that acquires an environmental image showing a direction faced by the rotating body in a peripheral environment of the work machine, a rotation determination unit that determines whether or not the rotating body is rotating, and a display control unit that outputs, to the display device, a display signal for displaying an image in which a side of the environmental image opposite to a rotation direction is blocked when the rotating body is determined to be rotating.

According to the above-mentioned embodiment, the display system can prevent motion sickness in an operator.

### BRIEF DESCRIPTION OF DRAWINGS

FIG. 1 is a schematic view illustrating the configuration of a remote operation system according to a first embodiment.

FIG. 2 is an external view of a work machine according to the first embodiment.

FIG. 3 is a view illustrating the configuration of an imaging device according to the first embodiment.

FIG. 4 is a schematic block diagram illustrating the configuration of a control device of a remote driving device according to the first embodiment.

FIG. 5 is a flow chart indicating a display control method due to a control device according to the first embodiment.

FIG. 6 is a view illustrating the difference in a display on a display device before and after initiating left rotation according to the first embodiment.

### DESCRIPTION OF EMBODIMENTS

### First Embodiment

### (Remote Driving System)

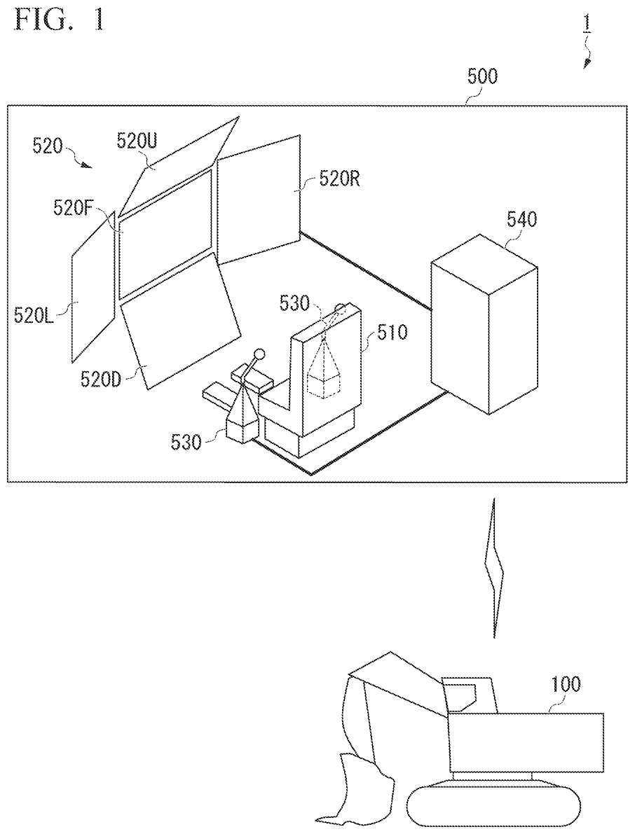

FIG. 1 is a schematic view illustrating the configuration of a remote operation system according to a first embodiment.

The remote operation system 1 comprises a work machine 100 that is actuated by remote operation, and a remote driving device 500 for carrying out the remote operation. The work machine 100 runs at a work site (for example, a mine or a quarry). The remote driving device 500 is provided at a geographical location (for example, in a city or within the work site) removed from the work machine 100. The work machine 100 and the remote driving device 500 are connected by communication means such as the internet.

The remote operation system 1 is a system for operating the work machine 100 by using the remote driving device 500.

The work machine 100 is actuated in accordance with operation signals received from the remote driving device 500.

The remote driving device 500 transmits operation signals input by operations of an operator to the work machine 100.

### (Configuration of Work Machine 100)

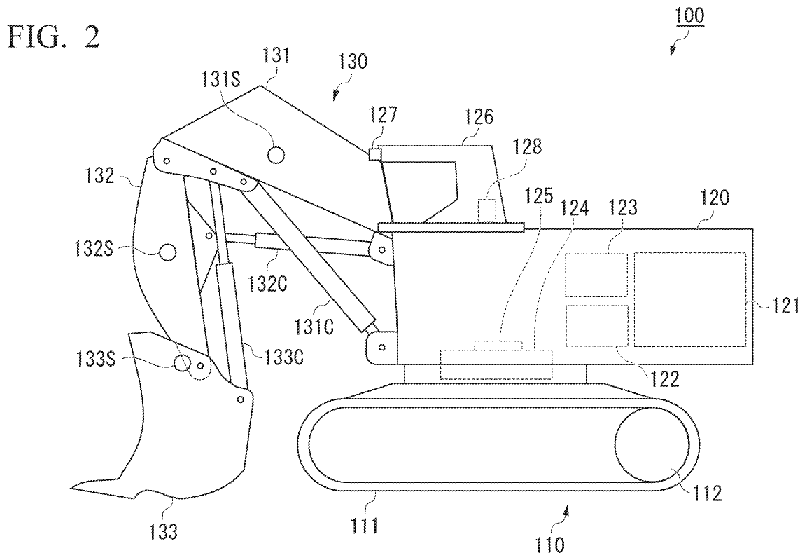

FIG. 2 is an external view of the work machine 100 according to the first embodiment.

The work machine 100 according to the first embodiment is a hydraulic shovel. The work machine 100 according to another embodiment may be a rotatable work machine other than a hydraulic shovel, for example, a crane, an electric shovel, etc.

The work machine 100 comprises a traveling body 110, a rotating body 120, and work equipment 130.

The traveling body 110 supports the work machine 100 so as to be capable of traveling. The traveling body 110 comprises two endless tracks 111 provided on the left and right, and two travel motors 112 for driving the respective endless tracks 111. The traveling body 110 is an example of a support.

The rotating body 120 is supported on the traveling body 110 so as to be capable of rotating about a center of rotation.

The work equipment 130 is driven hydraulically. The work equipment 130 according to another embodiment may be driven electrically. The work equipment 130 is supported on the front portion of the rotating body 120 so as to be capable of being driven in the vertical direction. In this case, the portion of the rotating body 120 to which the work equipment 130 is attached is referred to as the front portion. Additionally, regarding the rotating body 120, with reference to the front portion, the portion on the opposite side is referred to as the rear portion, the portion on the left side is referred to as the left portion, and the portion on the right side is referred to as the right portion.

### (Configuration of Work Equipment 130)

The work equipment 130 comprises a boom 131, an arm 132, and a bucket 133. The work equipment 130 is driven by extending and retracting a boom cylinder 131C, an arm cylinder 132C, and a bucket cylinder 133C. A boom angle sensor 131S, an arm angle sensor 132S, and a bucket angle sensor 133S are respectively mounted on the boom 131, the arm 132, and the bucket 133.

A proximal end of the boom 131 is attached to the rotating body 120 by a pin.

The arm 132 couples the boom 131 with the bucket 133. The proximal end of the arm 132 is attached to the distal end of the boom 131 by a pin.

The bucket 133 comprises a blade for excavating dirt, etc. and a container for containing the excavated dirt. The proximal end of the bucket 133 is attached to the distal end of the arm 132 by a pin.

The boom cylinder 131C is, for example, a hydraulic cylinder for driving the boom 131. The proximal end of the boom cylinder 131C is attached to the rotating body 120. The distal end of the boom cylinder 131C is attached to the boom 131.

The arm cylinder 132C is, for example, a hydraulic cylinder for driving the arm 132.

The proximal end of the arm cylinder 132C is attached to the rotating body 120. The distal end of the arm cylinder 132C is attached to the arm 132.

The bucket cylinder 133C is, for example, a hydraulic cylinder for driving the bucket 133. The proximal end of the bucket cylinder 133C is attached to the boom 131. The distal end of the bucket cylinder 133C is attached to the bucket 133.

The boom angle sensor 131S is attached to the boom 131 and detects the inclination angle of the boom 131.

The arm angle sensor 132S is attached to the arm 132 and detects the inclination angle of the arm 132.

The bucket angle sensor 133S is attached to the bucket 133 and detects the inclination angle of the bucket 133.

The boom angle sensor 131S, the arm angle sensor 132S, and the bucket angle sensor 133S according to the first embodiment detect the inclination angles with respect to the horizontal plane. The angle sensors according to other embodiments are not limited thereto, and may detect inclination angles with respect to other reference planes. For example, in another embodiment, the angle sensors may detect relative rotation angles by means of potentiometers provided at the proximal ends of the boom 131, the arm 132, and the bucket 133, or may detect inclination angles by measuring the cylinder lengths of the boom cylinder 131C, the arm cylinder 132C, and the bucket cylinder 133C, and converting the cylinder lengths to angles.

### (Configuration of Rotating Body 120)

The rotating body 120 comprises an engine 121, a hydraulic pump 122, a control valve 123, a rotation motor 124, an angular velocity sensor 125, a driving cabin 126, imaging devices 127, and a control device 128.

The engine 121 is an engine for driving the hydraulic pump 122. The engine 121 is an example of a drive power source.

The hydraulic pump 122 is a variable-capacity pump driven by the engine 121. The hydraulic pump 122 supplies hydraulic fluid to the respective actuators (the boom cylinder 131C, the arm cylinder 132C, the bucket cylinder 133C, the travel motor 112, and the rotation motor 124) via the control valve 123.

The control valve 123 controls the flow rates of the hydraulic fluid supplied from the hydraulic pump 122.

The rotation motor 124 is driven by the hydraulic fluid supplied from the hydraulic pump 122 via the control valve 123 to rotate the rotating body 120. The rotation motor 124 comprises the angular velocity sensor 125 for measuring the rotation velocity. The angular velocity sensor 125 may be constituted, for example, by a rotary encoder or a gyrosensor. The angular velocity sensor 125 may, for example, be an inertial measurement unit (IMU).

The rotating body 120 comprises a driving cabin 126. The driving cabin 126 is provided on the left side of the work equipment 130. The driving cabin 126 comprises a front camera 127F, a left-side camera 127L, a right-side camera 127R, an up-side camera 127U, and a down-side camera 127D. Hereinafter, the front camera 127F, the left-side camera 127L, the right-side camera 127R, the up-side camera 127U, and the down-side camera 127D will also be referred to collectively as imaging devices 127. Captured images from the imaging devices 127 are an example of environmental images showing a direction faced by the rotating body 120 in a peripheral environment of the work machine 100.

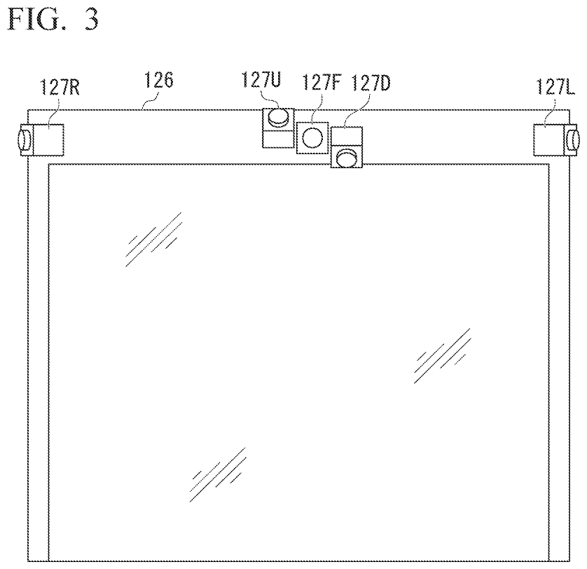

FIG. 3 is a view illustrating the configuration of imaging devices 127 according to the first embodiment. In the first embodiment, the imaging devices 127 are installed on front and upper portions inside the driving cabin 126. The The front camera 127F captures images looking in front of the driving cabin 126. The left-side camera 127L captures images in the left forward direction of the driving cabin 126. The right-side camera 127R captures images in the right forward direction of the driving cabin 126. The up-side camera 127U captures images in the upward forward direction of the driving cabin 126. The down-side camera 127D captures images in the downward forward direction of the driving cabin 126. Examples of the imaging devices 127 include, for example, imaging devices using CCD (Charge Coupled Device) sensors and CMOS (Complementary Metal Oxide Semiconductor) sensors. The work machine 100 according to another embodiment may not comprise a driving cabin 126 in the case in which it is to be driven by remote operation or by unmanned driving. In this case, the imaging devices 127 are installed at the front portion of the rotating body 120. Additionally, in another embodiment, the imaging devices 127 may be installed at a location other than the front portion of the rotating body 120, for example, on a side portion of the rotating body, etc.

The control device 128 transmits measurement data from the various sensors (the angular velocity sensor 125, the imaging devices 127, the boom angle sensor 131S, the arm angle sensor 132S, and the bucket angle sensor 133S) provided on the work machine 100 to the remote driving device 500. The control device 128 may comprise an encoder for encoding the images captured by the imaging devices 127. Additionally, the control device 128 receives operation signals from the remote driving device 500, and drives the work equipment 130, the rotating body 120, or the traveling body 110 based on the received operation signals.

### (Remote Driving Device 500)

The remote driving device 500 comprises a driving seat 510, a display device 520, an operation device 530, and a control device 540.

The display device 520 is disposed in front of the driving seat 510. The display device 520 is positioned to face an operator when the operator is seated on the driving seat 510. The display device 520, as illustrated in FIG. 1, is constituted by a front display unit 520F, a left-side display unit 520L, a right-side display unit 520R, an up-side display unit 520U, and a down-side display unit 520D, which are arrayed. The left-side display unit 520L is provided on the left side of the front display unit 520F. The right-side display unit 520R is provided on the right side of the front display unit 520F. The up-side display unit 520U is provided on the upper side of the front display unit 520F. The down-side display unit 520D is provided on the lower side of the front display unit 520F. The display device 520 is arranged to occupy much of the field of view of the operator when the operator is seated on the driving seat 510. When the operator is seated on the driving seat 510 and looks at the front display unit 50F (when the front display unit 520F is in the effective field of view), the left-side display unit 520L, the right-side display unit 520R, the up-side display unit 520U, and the down-side display unit 520D are all located in the operator's peripheral vision.

In other embodiments, the number of displays constituting the display device 520 is not limited to the above. For example, the display device 520 may be constituted by a single display. Alternatively, the display device 520 may project images onto a curved surface or a spherical surface by means of a projector, etc. In this case also, the display device 520 is provided so as to span regions that are in the operator's peripheral vision when the operator, seated on the driving seat 510, looks at the center of the display device 520.

The operation device 530 is disposed near the driving seat 510. The operation device 530 is located within a range allowing operation by an operator when the operator is seated on the driving seat 510. The operation device 530 comprises, for example, an electric lever and an electric pedal. Due to the operator operating the electric lever and the electric pedal, the operation device 530 outputs operation signals of the boom 131, the arm 132, and the bucket 133, rotation operation signals of the rotating body 120, and traveling operation signals of the traveling body 110.

The control device 540 displays captured images received from the work machine 100 on the display device 520. Specifically, the control device 540 displays captured images from the front camera 127F on the front display unit 520F, displays captured images from the left-side camera 127L on the left-side display unit 520L, displays captured images from the right-side camera 127R on the right-side display unit 520R, displays captured images from the up-side camera 127U on the up-side display unit 520U, and displays captured images from the down-side camera 127D on the down-side display unit 520D. The control device 540 is an example of a display control device.

Additionally, the control device 540 transmits, to the work machine 100, the operation signals input to the operation device 530.

### (Control Device 540 of Remote Driving Device 500)

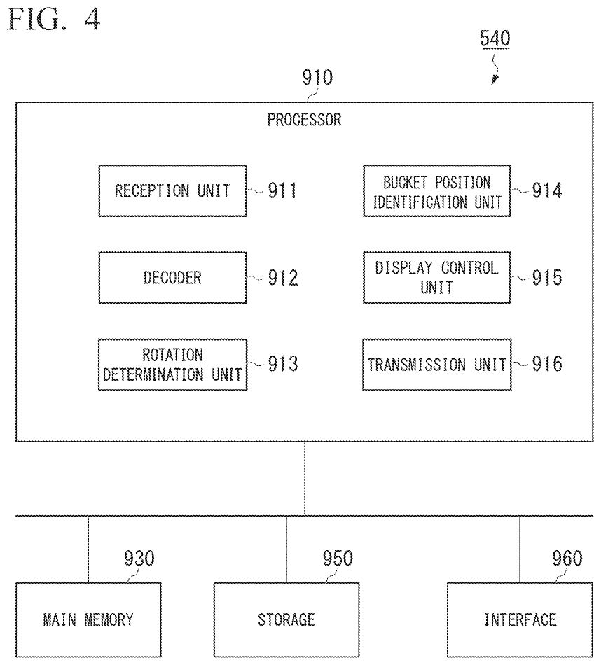

FIG. 4 is a schematic block diagram illustrating the configuration of the control device of the remote driving device according to the first embodiment.

The control device 540 is a computer comprising a processor 910, a main memory 930, storage 950, and an interface 960. The storage 950 stores a program. The processor 910 reads the program from the storage 950, loads it in the main memory 930, and executes processing in accordance with the program.

Examples of the storage 950 include an HDD (Hard Disk Drive), an SSD (Solid State Drive), a magnetic disk, a magneto-optic disk, a CD-ROM (Compact Disc Read-Only Memory), a DVD-ROM (Digital Versatile Disc Read-Only Memory), a semiconductor memory, etc. The storage 950 may be internal media directly connected to a common communication line of the control device 540, or may be external media connected to the control device 540 via an interface 960. The storage 950 is a non-transitory, tangible storage medium.

In other embodiments, the control device 540 may comprise, in addition to the above-mentioned features or instead of the above-mentioned features, a custom LSI (Large-Scale Integrated Circuit) such as a PLD (Programmable Logic Device) or a semi-custom LSI such as an ASIC (Application-Specific Integrated Circuit). Examples of PLDs include PAL (Programmable Array Logic), GAL (Generic Array Logic), CPLD (Complex Programmable Logic Device), and FPGA (Field-Programmable Gate Array). In this case, some or all of the functions realized by the processor 910 may be realized by said integrated circuit.

The processor 910, by executing the program, comprises a reception unit 911, a decoder 912, a rotation determination unit 913, a bucket position identification unit 914, a display control unit 915, and a transmission unit 916.

The reception unit 911 receives measurement data from the work machine 100. The received measurement data includes measurement data from the angular velocity sensor 125, captured images from the front camera 127F, captured images from the left-side camera 127L, captured images from the right-side camera 127R, captured images from the up-side camera 127U, captured images from the down-side camera 127D, measurement data from the boom angle sensor 131S, measurement data from the arm angle sensor 132S, and measurement data from the bucket angle sensor 133S. The reception unit 911 is an example of an acquisition unit.

The decoder 912 decodes the captured images received by the reception unit 911.

The rotation determination unit 913 determines whether or not the rotating body 120 on the work machine 100 is rotating based on the measurement data from the angular velocity sensor 125 received by the reception unit 911. The rotation determination unit 913, in the case in which the rotating body 120 is determined to be rotating, identifies the rotation direction. Specifically, if the absolute value of the measurement data of the angular velocity sensor 125 exceeds a prescribed threshold value, the rotation determination unit 913 determines that the rotating body 120 is rotating. Additionally, if the sign of the measurement data of the angular velocity sensor 125 is positive, the rotation determination unit 913 determines that the rotating body 120 is rotating to the left, and if the sign of the measurement data of the angular velocity sensor 125 is negative, the rotation determination unit 913 determines that the rotating body 120 is rotating to the right. In other embodiments, the rotation determination unit 913 may determine that the rotating body 120 is rotating when the operation amount of the operation device 530 exceeds a prescribed threshold value.

The bucket position identification unit 914 identifies the position of a blade tip of the bucket 133, with reference to the rotating body 120, based on the measurement data from the boom angle sensor 131S, the measurement data from the arm angle sensor 132S, and the measurement data from the bucket angle sensor 133S received by the reception unit 911.

Specifically, the bucket position identification unit 914 acquires the vertical direction component and the horizontal direction component of the axis of the boom 131 based on the measurement data from the boom angle sensor 131S and the known length of the boom 131 (the distance from the pin at the proximal end to the pin at the distal end). The bucket position identification unit 914 determines the vertical direction component and the horizontal direction component of the axis of the arm 132 based on the measurement data from the arm angle sensor 132S and the known length of the arm 132. The bucket position identification unit 914 determines the vertical direction component and the horizontal direction component of the axis of the bucket 133 from the proximal end to the blade tip based on the measurement data from the bucket angle sensor 133S and the known shape of the bucket 133.

The bucket position identification unit 914 identifies, as the position of the blade tip of the bucket 133, a position separated from the position of the proximal end of the boom 131 on the work machine 100 by the sum of the vertical direction components and the horizontal direction components of the axes of the boom 131, the arm 132, and the bucket. The bucket position identification unit 914 may identify the position of the proximal end of the bucket 133 instead of the position of the blade tip of the bucket 133.

The display control unit 915 outputs, to corresponding display units in the display device, display signals of captured images decoded by the decoder 912. The display control unit 915 determines whether or not each captured image requires to be displayed based on the determination results from the rotation determination unit 913 and the position of the blade tip of the bucket 133 identified by the bucket position identification unit 914.

The transmission unit 916 transmits, to the work machine 100, the operation signals input to the operation device 530.

### (Display Control Method of Control Device 540)

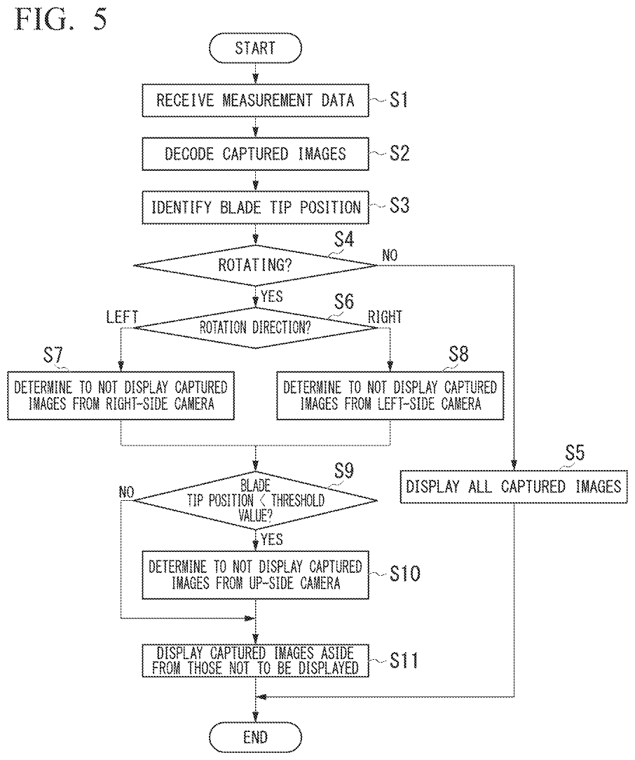

The display control method due to the control device 540 according to the first embodiment will be explained with reference to the drawings. FIG. 5 is a flow chart indicating a display control method due to the control device 540 according to the first embodiment. The control device 540 repeatedly executes the process below each time measurement data is received from the work machine 100.

First, the reception unit 911 receives measurement data from the work machine 100 (step S1). The decoder 912 decodes the respective captured images received by the reception unit 911 (step S2). Additionally, the bucket position identification unit 914 identifies the position of the blade tip of the bucket 133 based on the measurement data from the boom angle sensor 131S, the arm angle sensor 132S, and the bucket angle sensor 133S (step S3).

Next, the rotation determination unit 913 determines whether or not the rotating body 120 of the work machine 100 is rotating based on the measurement data from the angular velocity sensor 125 received by the reception unit 911 (step S4).

If the rotation determination unit 913 has not determined that the rotating body 120 is rotating (step S4: NO), then the display control unit 915 outputs, to the display device 520, display signals for displaying all of the captured images that have been decoded on corresponding display units (step S5). That is, the display control unit 915 makes the front display unit 520F display the captured images from the front camera 127F, makes the left-side display unit 520L display the captured images from the left-side camera 127L, makes the right-side display unit 520R display the captured images from the right-side camera 127R, makes the up-side display unit 520U display the captured images from the up-side camera 127U, and makes the down-side display unit 520D display the captured images from the down-side camera 127D.

On the other hand, if the rotation determination unit 913 has determined that the rotating body 120 is rotating (step S4: YES), then the rotation determination unit 913 identifies the rotation direction based on the measurement data from the angular velocity sensor 125 (step S6). If the rotation direction is to the left (step S6: Left), then the display control unit 915 determines that the captured images from the right-side camera 127R showing the region on the side opposite to the rotation direction are not to be displayed (step S7). On the other hand, if the rotation direction is to the right (step S6: Right), then the display control unit 915 determines that the captured images from the left-side camera 127L showing the region on the side opposite to the rotation direction are not to be displayed (step S8).

Next, the display control unit 915 determines whether or not the height of the blade tip of the bucket 133 (the height from the bottom surface of the traveling body 110 to the proximal end of the bucket 133) is lower than a prescribed threshold value (step S9). If the height of the blade tip of the bucket 133 is lower than the prescribed threshold value (step S9: YES), then the display control unit 915 determines that the display control unit 915 will not display captured images from the up-side camera 127U (step S10).

Furthermore, the display control unit 915 outputs, to the display device 520, display signals for displaying, on the corresponding display units, captured images, among the captured images that have been decoded, other than those that have been determined will not be displayed (step S11).

### (Functions and Effects)

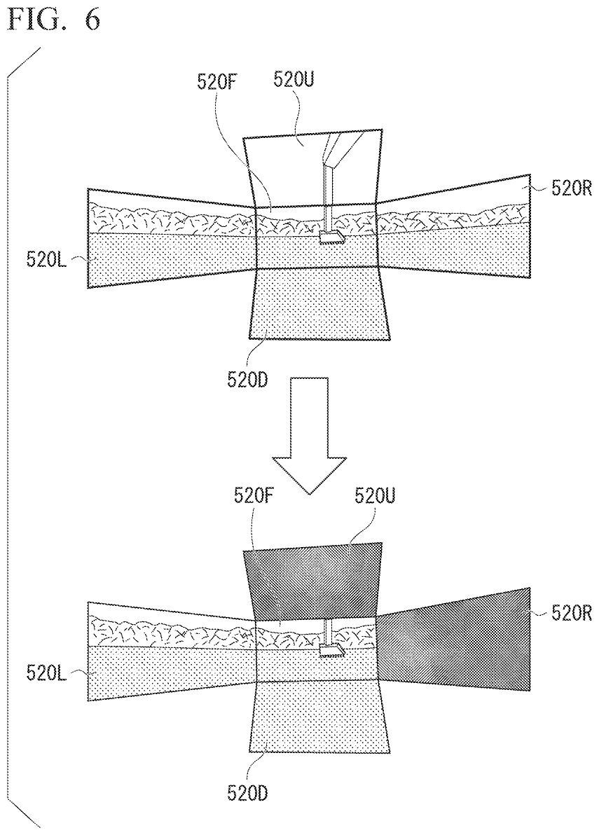

Thus, the control device 540 according to the first embodiment comprises a reception unit 911, a rotation determination unit 913, and a display control unit 915. The reception unit 911 acquires captured images captured by the imaging devices 127. The rotation determination unit 913 determines whether or not the rotating body 120 is rotating. If the rotating body 120 is determined to be rotating, the display control unit 915 outputs, to the display device 520, display signals for displaying images in which partial regions of the captured images on the side opposite to the rotation direction are blocked. FIG. 6 is a view illustrating the difference in the display on the display device 520 before and after initiating left rotation according to the first embodiment.

In a rotation operation, in order to perform correct operations, an operator is required to look at the captured image in the rotation direction and the captured image in the frontward direction in which the bucket 133 appears. On the other hand, the direction opposite to the rotation direction is not closely viewed by the operator. However, even when it is not closely viewed, if there is a large movement in a portion appearing in the field of view, there is a risk that motion sickness will be induced. Therefore, as illustrated in FIG. 6, when rotating in which the entire captured image changes greatly, the control device 540 according to the first embodiment can prevent the operator from experiencing motion sickness by blocking captured images that are unimportant, while displaying captured images that are important.

Additionally, the display device 520 of the remote driving device 500 according to the first embodiment is provided so as to span regions that are in the operator's peripheral vision (for example, a range from approximately 30 degrees to 100 degrees from the line of sight) when the operator, seated on the driving seat 510, looks at the center of the display device 520. As a result thereof, the remote driving device 500 can construct an environment close to that when the operator is actually on board the work machine and can reduce the gap between remote operation and actual machine operation. On the other hand, since the display device 520 occupies much of the field of view of the operator, there is a possibility that the operator will experience motion sickness if the entire screen moves in unison. In particular, motion sickness tends to be induced by perceiving large movements in one's peripheral vision. Therefore, the control device 540 according to the first embodiment outputs display signals for displaying images in which regions of the captured images that are in the operator's peripheral vision when displayed on the display device 520 and that are on a side opposite to the rotation direction are blocked. As a result thereof, motion sickness can be prevented by preventing motion from occurring in the operator's peripheral vision during rotation.

Additionally, the respective display units in the display device 520 according to the first embodiment display the captured images captured by the corresponding imaging devices 127. In this case, when it is determined that the rotating body 120 is rotating to the right, the control device 540 makes the front display unit 520F display the captured images from the front camera 127F and makes the right-side display unit 520R display the captured images from the right-side camera 127R without making the left-side display unit 520L display the captured images from the left-side camera 127L. Additionally, when it is determined that the rotating body 120 is rotating to the left, the control device 540 makes the front display unit 520F display the captured images from the front camera 127F and makes the left-side display unit 520L display the captured images from the left-side camera 127L without making the right-side display unit 520R display the captured images from the right-side camera 127R. Additionally, when it is determined that the rotating body 120 is not rotating, the control device 540 makes the right-side display unit 520R display the captured images from the right-side camera 127R, makes the front display unit 520F display the captured images from the front camera 127F, and makes the left-side display unit 520L display the captured images from the left-side camera 127L. Thus, the control device 540 can prevent motion from occurring in the operator's peripheral vision during rotation, without performing any particular image processing, by determining whether or not any of the captured images are to be displayed.

Additionally, when it is determined that the rotating body 120 is rotating, the control device 540 according to the first embodiment does not make the up-side display unit 520U display the captured images from the up-side camera 127U, and when it is determined that the rotating body 120 is not rotating, the control device 540 makes the up-side display unit 520U display the captured images from the up-side camera 127U. As a result thereof, the images appearing in the operator's peripheral vision can be further reduced, thereby further lowering the possibility that motion sickness will occur. In particular, when it is determined that the rotating body 120 is rotating, the control device 540 according to the first embodiment determines whether or not to display the captured images from the up-side camera 127U based on the position of the work equipment 130. For example, when the bucket 133 is located at a high position, the captured images from the up-side camera 127U become important for checking that the bucket 133 will not come into contact with obstacles located above. By determining whether or not the captured images from the upward camera are important depending on the height of the bucket 133, the control device 540 according to the first embodiment can display the captured images when they are important without displaying them when they are not important.

There are cases in which the up-side camera 127U is always important regardless of the height of the blade tip of the bucket 133, such as in cases in which there are power lines above. In this case, the captured images from the up-side camera 127U may always be displayed regardless of the height of the blade tip of the bucket 133 by inputting instructions, in advance, to the control device 540 that the up-side camera 127U is always to be kept on.

### Other Embodiments

While an embodiment has been explained in detail with reference to the drawings above, the specific configuration is not limited to that described above, and various design changes, etc. are possible. That is, in another embodiment, the order of the above-mentioned processes can be changed as appropriate. Additionally, some of the processes may be executed in parallel.

The control device 540 in the above-mentioned embodiment may be constituted by a single computer, or the configuration of the control device 540 may be arranged by being divided between multiple computers, and the multiple computers may cooperate with each other to function as the control device 540. In this case, some of the computers constituting the control device 540 may be installed in the work machine 100, and the other computers may be provided outside the work machine 100.

For example, in the remote operation system 1 according to another embodiment, the rotation determination unit 913 may be provided in the control device 128 in the work machine 100. In this case, the control device 128 may be configured so that, when it is determined that rotation is occurring, the captured images from the camera capturing images on the side opposite to the rotation direction are not decoded or are not transmitted.

Additionally, for example, in a remote operation system 1 according to another embodiment, the bucket position identification unit 914 may be provided in the control device 128 in the work machine 100. In this case, the control device 128 may transmit the position of the blade tip of the bucket 133 to the remote driving device 500 instead of the measurement data from the boom angle sensor 131S, the arm angle sensor 132S, and the bucket angle sensor 133S. Additionally, the control device 128 may be configured so as to determine whether or not the height of the blade tip of the bucket 133 is lower than a prescribed threshold value, and so that, when it is determined that the height is equal to or greater than the threshold value, the captured images from the up-side camera 127U are not decoded or are not transmitted.

The control device 540 according to the above-mentioned embodiment determines whether or not rotation is occurring based on received measurement data from the angular velocity sensor 125. However, there is no limitation thereto. For example, the control device 540 according to another embodiment may determine whether or not rotation is occurring based on operation signals form the operation device 530. In this case, there is a lag caused by communication between operation of the operation device 530 and when the rotation actually starts. For this reason, the control device 540 may determine that the rotating body 120 is rotating after a certain period of time has elapsed from a timing at which the value of the operation signal became large.

Additionally, the control device 540 according to another embodiment may determine whether or not the rotating body 120 is rotating by analyzing captured images that have been received.

Additionally, the work machine 100 according to the above-mentioned embodiment comprises multiple cameras. However, there is no limitation thereto. For example, the work machine 100 according to another embodiment may comprise a single wide-angle camera as the imaging device 127, and the captured images from said wide-angle camera may be divided and allocated to the multiple display units.

Additionally, the display device 520 in the remote driving device 500 according to the above-mentioned embodiment displays captured images from the image capture devices 127. However, there is no limitation thereto. For example, the display device 520 according to another embodiment may display images of the peripheral environment of the work machine 100 in the direction faced by the work machine 100 drawn as a result of simulations of the behavior of the work machine 100.

Specifically, the control device 540 arranges three-dimensional models of the work machine 100 and the terrain at a work site in virtual space, and simulates the orientation and the position of the work machine 100 based on measurement data received from the work machine 100. The control device 540 can generate an environmental image in the direction faced by the rotating body 120 in the peripheral environment of the work machine 100 by setting the viewpoint of a rendering camera to be that faced by (for example, in front of the driving cabin) the model of the work machine 100 in the virtual space, setting the line-of-sight direction straight forward from the work machine 100, and rendering the three-dimensional models of the work machine 100 and the terrain of the work site.

Additionally, the control device 540 may display the shapes of the traveling body 110 and the work machine 130, drawn with lines or by being filled in, based on the orientation of the three-dimensional model of the work machine 100, so as to be overlaid on captured images or environmental images.

Additionally, the control device 540 according to the above-mentioned embodiment determines whether or not to display the captured images from the up-side camera 127U based on the height of the blade tip of the bucket 133 during rotation of the rotating body 120. However, there is no limitation thereto. For example, the control device 540 according to another embodiment may determine that, during rotation of the rotating body 120, the captured images from the up-side camera 127U are never to be displayed, or the captured images from the up-side camera 127U are always to be displayed. In this case, the display control unit 915 in the control device 540 determines whether or not the respective captured images require to be displayed without using the position of the blade tip of the bucket 133 identified by the bucket position identification unit 914. Additionally, the control device 540 according to another embodiment may determine that the captured images from the down-side camera 127D are not to be displayed during rotation of the rotating body 120.

Additionally, the display device 520 in the remote driving device 500 according to the above-mentioned embodiment comprises multiple display units. However, there is no limitation thereto. For example, the display device 520 according to another embodiment may be constituted by a single display. Alternatively, the display device 520 may project images onto a curved surface or a spherical surface by means of a projector, etc. In this case also, the display device 520 is provided so as to span regions that are in the operator's peripheral vision when the operator, seated on the driving seat 510, looks at the center of the display device 520. The control device 540 generates a single combined image by combining the respective captured images from the imaging devices 127 and displays the combined image on the display device 520. When it is determined that the rotating body 120 is rotating, the control device 540 may mask, with black coloring, etc., a partial region of the combined image on the side opposite to the rotation direction, particularly a region located in the peripheral vision of the operator.

Additionally, the blocking of the partial region in the image in the above-mentioned embodiment is implemented by not displaying the partial region. However, there is no limitation thereto. For example, in another embodiment, the partial image may be blocked by largely reducing the brightness (blacking out), largely increasing the brightness (whiting out), largely reducing the contrast, or blurring the image in the partial region, thereby reducing the image variation in the region.

According to the embodiments described above, the display system can prevent motion sickness in an operator.

1. A display system used for operating a work machine including a rotating body that rotates about a center of rotation, the display system comprising:
a display device; and
a display control device configured to output a display signal in order to display an image on the display device, the display control device including
an acquisition unit configured to acquire an environmental image showing a direction faced by the rotating body in a peripheral environment of the work machine,
a rotation determination unit configured to determine whether or not the rotating body is rotating, and
a display control unit configured to output, to the display device, a display signal in order to display an image in which a side of the environmental image opposite to a rotation direction is blocked when the rotating body is determined to be rotating.

2. The display system according to claim 1, wherein
the display device is provided so as to span regions that are in an operator's peripheral vision when the operator, seated on a driving seat, looks at a center of the display device, and
the display control unit is configured to output the display signal in order to display an image in which a region of the environmental image that is in the operator's peripheral vision when displayed on the display device and that is on the side opposite to the rotation direction is blocked.

3. The display system according to claim 2, wherein
the work machine includes an imaging device configured to image a peripheral environment of the work machine, and
the acquisition unit is configured to acquire a captured image from the imaging device as the environmental image.

4. The display system according to claim 3, wherein:
the work machine includes, as the imaging device,
a front camera configured to capture images in front of the work machine,
a left-side camera configured to capture images on a left side of the work machine, and
a right-side camera configured to capture images on a right side of the work machine;
the display device includes
a front display unit that is provided in front of the driving seat and that is configured to display the captured images from the front camera, which are environmental images,
a left-side display unit that is provided on a left side of the front display unit and at a position in the operator's peripheral vision when the operator seated in the driving seat looks at the front display unit, and that is configured to display the captured images from the left-side camera, which are environmental images, and
a right-side display unit that is provided on a right side of the front display unit and at a position in the operator's peripheral vision when the operator seated in the driving seat looks at the front display unit, and that is configured to display the captured images from the right-side camera, which are environmental images; and
the display control unit is configured to
when the swinging body is determined to be rotating to the right, make the front display unit display the captured images from the front camera and make the right-side display unit display the captured images from the right-side camera, without making the left-side display unit display the captured images from the left-side camera,
when the swinging body is determined to be rotating to the left, make the front display unit display the captured images from the front camera and make the left-side display unit display the captured images from the left-side camera, without making the right-side display unit display the captured images from the right-side camera, and
when the swinging body is determined to not be rotating, make the right-side display unit display the captured images from the right-side camera, make the front display unit display the captured images from the front camera, and makes the left-side display unit display the captured images from the left-side camera.

5. The display system according to claim 4, wherein
the work machine further includes an up-side camera configured to capture images from the front upper side of the work machine;
the display device further includes an up-side display unit that is provided on an upper side of the front display unit and at a position in the operator's peripheral vision when the operator seated in the driving seat looks at the front display unit, and that is configured to display the captured images from the up-side camera; and
the display control unit is configure to
not make the up-side display unit display the captured images from the up-side camera when the rotating body is determined to be rotating, and
make the up-side display unit display the captured images from the up-side camera when the rotating body is determined to not be rotating.

6. The display system according to claim 4, wherein:
the work machine further includes work equipment provided on the rotating body, and an up-side camera configured to capture images from the front upper side of the work machine;
the display device further includes an up-side display unit that is provided on an upper side of the front display unit and at a position in the operator's peripheral vision when the operator seated in the driving seat looks at the front display unit, and that is configured to display the captured images from the up-side camera; and
the display control unit is configured to
make the up-side display unit display the captured images from the up-side camera when the rotating body is determined to not be rotating, and
determine whether or not to display the captured images from the up-side camera on the up-side display unit based on a position of the work equipment when the rotating body is determined to be rotating.

7. A display control method in a display device used for operating a work machine including a rotating body that rotates about a center of rotation, the display control method comprising:
acquiring an environmental image showing a direction faced by the rotating body in the peripheral environment of the work machine;
determining whether or not the rotating body is rotating; and
a step of outputting, to the display device, a display signal in order to display an image in which a side of the environmental image opposite to a rotation direction is blocked when the rotating body is determined to be rotating.

8. A remote driving device provided outside a work machine including a rotating body that rotates about a center of rotation, the remote driving device comprising:
a display device; and
a display control device that outputs a display signal for displaying an image on the display device, the display control device including
an acquisition unit configured to acquire an environmental image showing a direction faced by the rotating body in a peripheral environment of the work machine,
a rotation determination unit configured to determine whether or not the rotating body is rotating, and
a display control unit configured to output, to the display device, a display signal in order to display an image in which a side of the environmental image opposite to a rotation direction is blocked when the rotating body is determined to be rotating.
